(19) United States
(12) Patent Application Publication
(10) Pub. No.: US 2005/0034387 A1
(43) Pub. Date: Feb. 17, 2005

(54) Metal profile for shop window construction, as well as a window frame, window holder, and/or similar devices made from such a profile

(76) Inventor: Jean Bourly, Reims (FR)

Correspondence Address: John S. Egbert;Harrison & Egbert, 7th Floor, 412 Main Street, Houston, TX, 77002, US

(21) Appl. No.: 10/916,867

(22) Filed: Aug. 12, 2004

Related U.S. Application Data
(63) Continuation-in-part of application No. 10/121,450, filed on Apr. 12, 2002, now abandoned.

(30) Foreign Application Priority Data
Apr. 19, 2001 (FR) 01/5306

(51) Int. Cl. E06B 3/00

(52) U.S. Cl. 52/204.5

(57) ABSTRACT

A metal profile for shop window construction, includes a fixed frame and an opening leaf, having a closed tubular cross section defining an interior space, the fixed frames and/or opening leaves present in the form of an arrangement of profiled sections defining the closed tubular cross section. Each profiled section includes at least one opening element, one closing element, and mechanisms for affixing the opening and closing elements to each other. Each opening element has at least one web and two wings defining at least two longitudinal edges extending from one end of the profiled section to the other, and linked by all or part of the web and the wings. Each closing element present at least in the form of a rabbet is designed to connect the two wings of the corresponding opening element in order to form the closed tubular cross-section. The closing element has, locally or not, at least one excessive thickness of material that makes it possible to create personalizable moldings, working with the material, and to create decoration of the profile.

### RELATED U.S. APPLICATIONS

The present utility patent application is a continuation-in-part application of U.S. patent application Ser. No. 10/121,450, filed on Apr. 12, 2002 and entitled “PROFILE FOR SHOP WINDOW CONSTRUCTION”, presently pending.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns a metal profile for shop window construction, as well as a window frame, window holder, and/or similar devices made from such a profile.

Although more particularly designed to form window frames, window holders and/or similar closing devices, the invention can also be used to form any other type of metal profile, such as, for example, profile for glazed roof construction, head guard, espagnolette bolt rods, shutter, leaf throat.

### BACKGROUND OF THE INVENTION

Currently, in the field of metal shop window construction, it is known to use steel or aluminum profiles.

These types of profiles, prior to their realization and commercialization, must be subjected to technical inspections that are more or less rigorous, according to the laws and regulations of the countries where they are installed.

It is thus that each type of profile must satisfy several tests, notably for waterproofing and resistance to forces, such as those generated by wind during a gale storm.

In addition, these tests are costly and produce significant time for approval, which postpones commercialization on the one hand, and suppresses the desire to create many designs.

Furthermore, the methods used today for the production of these profiles do not allow small series production at reasonable costs. In order to meet their customers' wishes, the manufacturers of metal profiles for shop window construction must thus manage a stock inventory of various parts available in large quantities. Besides, even with such a solution, it can be understood that they cannot comply with an order for profiles whose cross-section does not appear in their catalogue.

The purpose of this invention is to propose a metal profile for shop window construction, comprised of a fixed frame and an opening leaf, having a closed tubular cross section defining an interior space, which remedies the shortcomings mentioned above while being transformable and/or polyvalent in order to provide a very wide range of profiles while limiting the number of references to be managed.

Another purpose of this invention is to propose a window profile, window holder and/or similar device, comprised of a profile whose cross-section can be adapted, at a satisfactory cost, to particular specifications.

Another purpose of the invention is to propose a metal profile for shop window construction which has a common base structure and the possibility for obtaining different decorative variations without requiring a systematic passage of technical inspections. In fact, once the base structure has been approved, the esthetic embodiment variations do not need to be retested.

An advantage of the invention is to suggest a top range effect, due to the selection of the material employed.

Other purposes and advantages of the invention appear in the following description, which is given only for indicative purposes and which does not purport to limit said invention.

### BRIEF SUMMARY OF THE INVENTION

The invention primarily concerns a profile for shop window construction, comprised of a fixed frame and an opening leaf, having a closed tubular cross section defining an interior space, the fixed frames and/or opening leaves present in the form of an arrangement of profiled sections defining the closed tubular cross section, each profiled section comprising at least one opening element, one closing element, and mechanisms for affixing the opening and closing elements to each other, each opening element comprising at least one web and two wings defining at least two longitudinal edges extending from one end of the profiled section to the other, and linked by all or part of the web(s) and the wing(s), each closing element present at least in the form of a rabbet designed to connect the two wings of the corresponding opening element in order to form the closed tubular cross-section, the closing element having, in addition, locally or not, at least one excessive thickness of material that makes it possible to create personalizable moldings, working with the material, and to create decoration of the profile.

The invention also concerns a window frame, window holder and/or similar device comprised of a frame such as the one described above.

### BRIEF DESCRIPTION OF THE SEVERAL VIEWS OF THE DRAWINGS

The invention will be understood better when reading the following description together with the appended drawings wherein:

FIG. 1 describes along a transversal cross-sectional plane, an example of profiles according to the invention.

FIGS. 2a to 2c describe partially and according to a transversal cross-sectional plane, an example of window, glazed door or similar according to the invention comprising profile(s) according to FIG. 1, machined differently from one Figure to the other.

FIG. 3 is a partial illustration, as a front view, of an embodiment of the layout according to the invention.

FIG. 4 is a cross-sectional view along the line IV-IV represented on previous FIG. 3.

FIG. 5 is a cross-sectional view along the line V-V represented on previous FIG. 3.

FIG. 6 is a cross-sectional view along the line VI-VI represented on previous FIG. 4.

FIG. 7 in a partial illustration according to a transversal cross-sectional plane of an additional example of window, glazed door and/or similar according to the invention, comprising other profile layouts, also complying with the invention, forming a frame and a chassis.

FIGS. 8a to 8g illustrate different examples of profile sections of the layout according to the invention.

FIG. 9 is a partial section view in three dimensions of a window profile finished according to a first decoration as shown in section view in FIG. 11.

FIG. 10 is another partial section view in three dimensions, of a window profile finished according to a second decoration as shown in section view in FIG. 12.

FIGS. 11 and 12 show, according to a transverse section plane, two examples respectively shown in FIGS. 9 and 10 of the window, window holder and/or similar device according to the invention, comprising one or more profiled sections machined differently in each drawing.

FIG. 13 is a three-dimensional view of a window holder.

FIG. 14 shows the profile shown in FIG. 8a equipped with its closing element.

### DETAILED DESCRIPTION OF THE INVENTION

The invention primarily involves a metal profile for shop window construction, comprised of a fixed frame and an opening leaf, having a closed tubular section defining an interior space 8. The fixed frames and/or opening leaves have the form of an arrangement of profiled sections 1, 2 defining the closed tubular section.

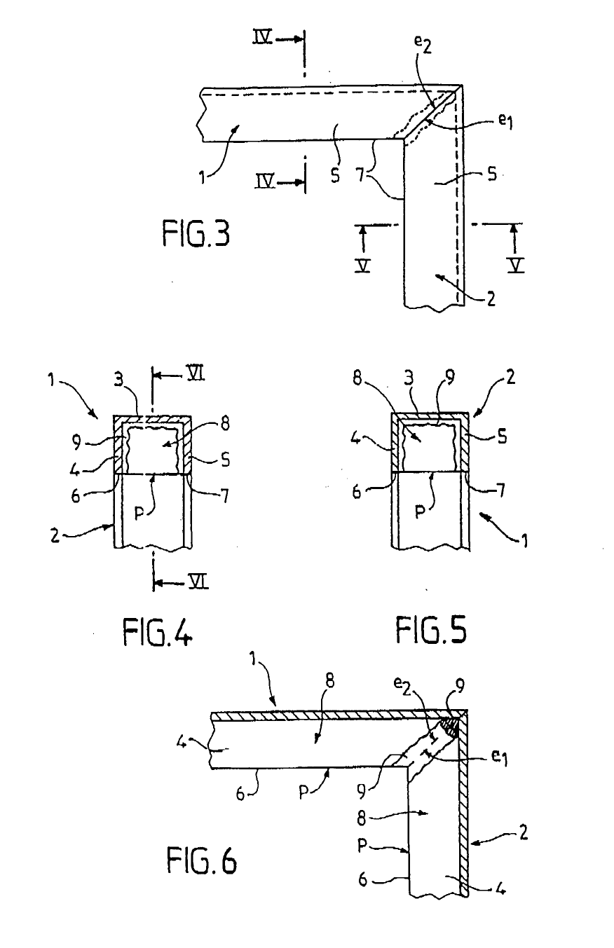

As shown in FIGS. 3 and 6, in the arrangement of the profiles 1, 2 according to the invention, these profiled sections are joined edge to edge at their end e₁, e₂. The profile is composed of extruded bronze.

Thanks to such a selection of material, the profiles according to the invention exhibit strength properties and an advantageous aesthetic effect. Besides, taking into account how easily bronze can be extruded, it becomes possible to obtain small series production, even to work on a case to case basis.

According to the invention, each profiled section 1, 2 comprises at least one opening element 3, 4, 5, one closing element 17, and mechanisms for affixing the opening and closing elements to each other, each opening element comprising at least one web 3 and two wings 4, 5 defining at least two longitudinal edges 6, 7 extending from one end of the profiled section 1, 2 to the other, and linked by all or part of the web(s) 3 and the wing(s) 4, 5.

According to the invention, each closing element 17 present at least in the form of a rabbet 14 designed to connect the two wings 4, 5 of the corresponding opening element 3, 4, 5 in order to form the closed tubular cross-section.

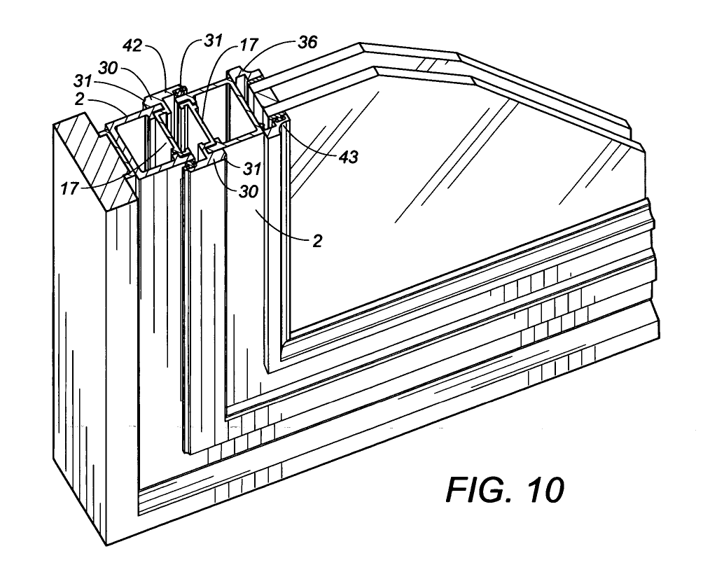

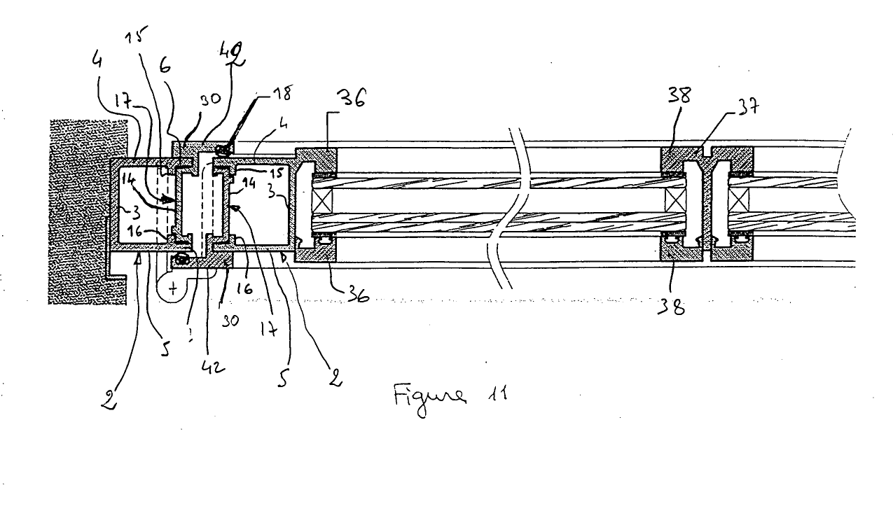

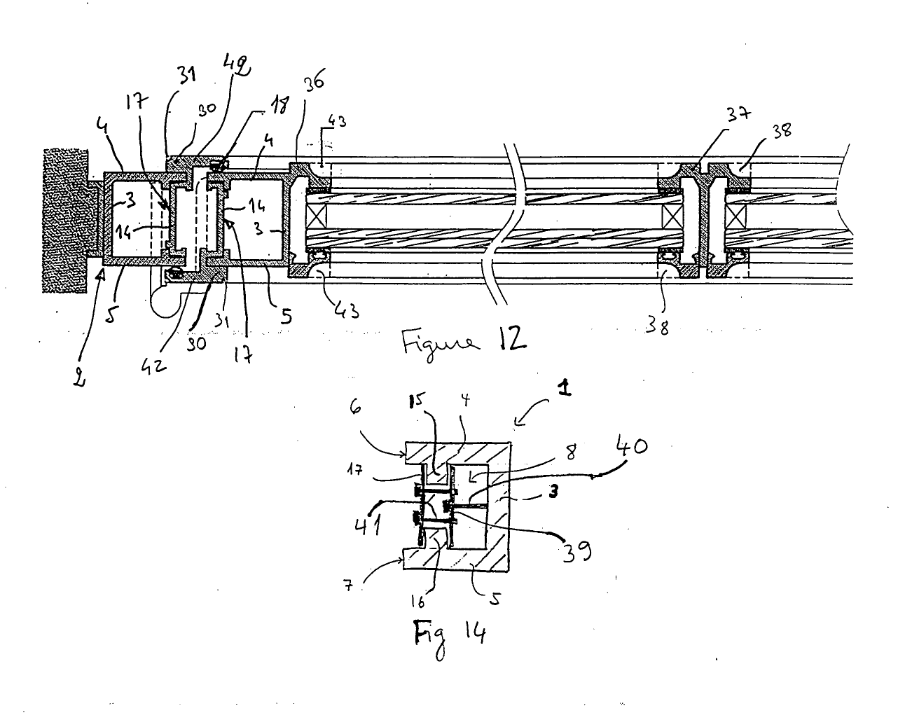

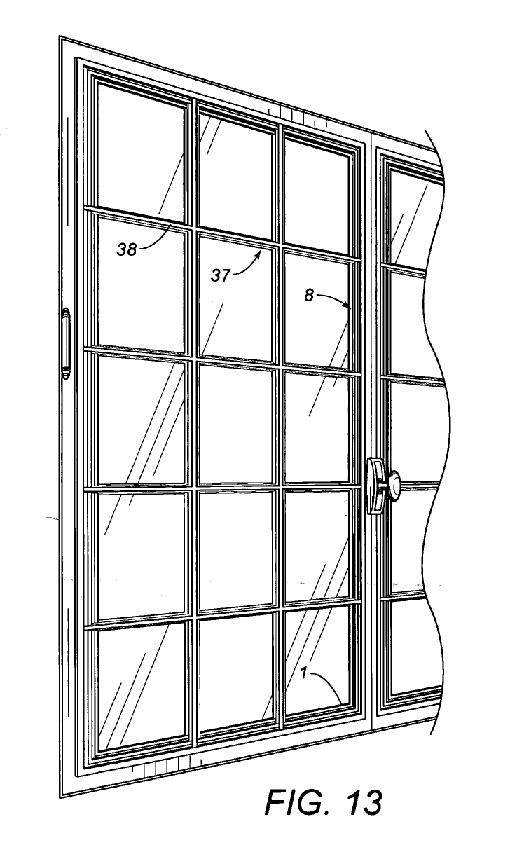

As shown in FIGS. 1, 9, 10, 11, and 12, according to an advantageous embodiment mode, the closing element 17 has, in addition, locally or not, at least one excessive thickness 30 of material that makes it possible to create personalizable moldings 31, working with the material, and to create decoration of the profile.

These excessive thicknesses are not necessary and do not affect the strength of the profiled section and, as a result, the profile. They are provided solely for the creation of the desired decoration.

According to a first embodiment mode, the rabbet 14 is extended by a covering wing 42, arranged longitudinally relative to the profiled section, and on the outside relative to the profile, at the level of which moldings 31 are provided.

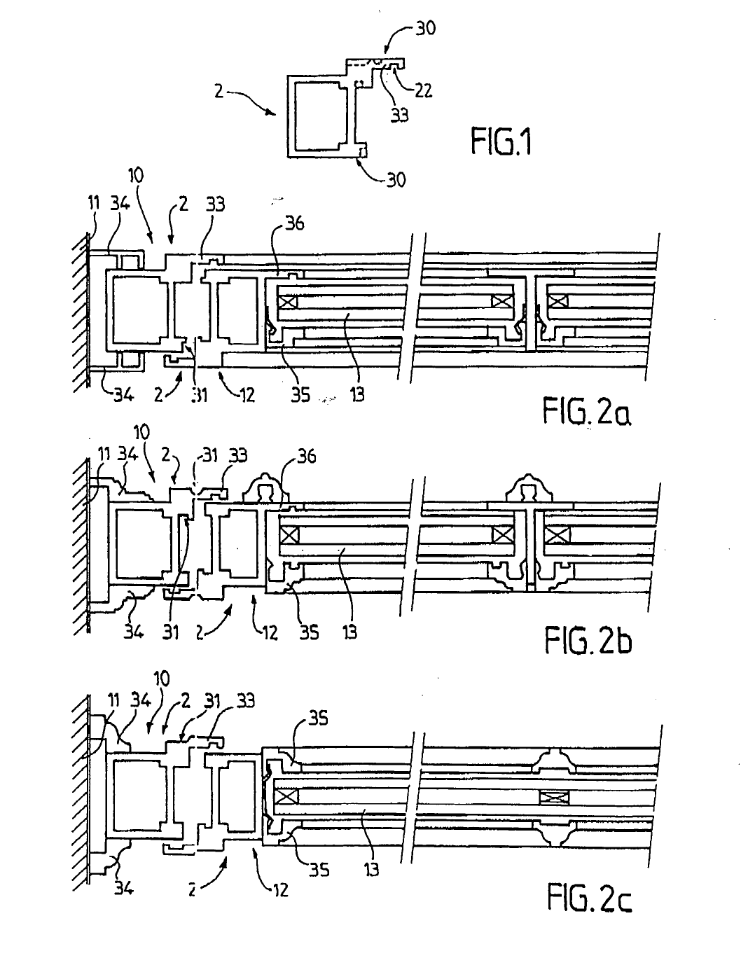

Said moldings 31 are obtained, notably, by machining operations such as shaping or planing. The cut-outs of material of FIGS. 2a to 2c are illustrated as dotted lines on FIG. 1.

It is thus possible to obtain from the same profile, profiles fitted with ribs and/or grooves of different nature and positioning, in order to adapt its style, by simple machining. There is thus provided a solution enabling to reduce the number of references to be managed and the number of profiles to be tested. Finishing the profiles can be made on a case to case basis.

According to the invention, the closing element 17 can exhibit a thickness enabling working the material for the realization of said moldings, i.e. a thickness greater than 1 mm or still greater than 2 let alone 2.5 mm. It may be, notably, a thickness ranging from 3 to 5 mm, for example a thickness of approx. 4 mm.

According to another embodiment, which might be combined with the previous one, said profile is fitted with localized excessive thicknesses, extending longitudinally at the level of which said moldings are provided.

More precisely, as illustrated, said profile can exhibit a substantially rectangular section and be fitted with said excessive thicknesses at some of tits apexes. Said excessive thickness(es) can have the form of an excrescency 33 situated in the extension of one and/or the other side of said profile.

Said excrescency(ies) may be fitted with a specific groove 22, intended for accommodating a gasket, not represented.

The window, glazed door or similar according to the invention comprises, for example, a frame 10 whereof the stanchion(s) are composed of said profiles 2. According to the example represented on FIGS. 2a to 2c, the profiles 2 of frame 10 are derived from the profiles 2 of FIG. 1. These profiles 2 are fixed to a wall 11 by means of linking parts 34 whereof the style can also be adapted.

Said window, glazed door or similar can also comprise a chassis 12 whereof the stanchion(s) are composed of said profiles 2. According to the example represented, the profiles 2 of the chassis 12 can also be derived from the profiles 2 of FIG. 1, as it is the case in FIG. 2c, or derived from another profile, fitted with an additional wing 36, as it is the case on FIGS. 2a and 2b. The profiles 2 of the chassis 12 enable to hold the panes 13 thanks, notably, to fastening parts 35 whereof the style can also be adapted.

The profile(s) 2 complying with the invention can exhibit, as required, sharp or rounded edges.

As illustrated on FIGS. 1 and 2, said profile(s) are, for example, tubular, of closed section. They can also be arranged with respect to one another, for example, to form window frames and/or chassis, glazed door or similar, by means of squares.

Another more advantageous solution may however be found and the invention concerns to that end a layout of profiles such as described above, assembled, edge to edge by their ends.

As illustrated on FIGS. 3 to 6, said profiles, referred to as 1, 2, are, for example, perpendicular, two by two. Their ends can be chamfered, The edges of the ends of said profiles will therefore be tilted, notably, of approx. 45° with respect to their longitudinal edges.

Each profile 1, 2 comprises at least a web 3 and a wing 4, 5 and exhibits at least two so-called longitudinal edges 6, 7, extending from one end to the other of the profile and linked, in all or in part of said webs 3 and of said wings 4, 5, each said profile delineating a so-called volume 8, circumscribed by said web(s) 3 and said wing(s) 4 linking said longitudinal edges 6, 7 and by a virtual plane P going through said edges.

Said profiles thus exhibit a “semi-open” right section, i.e. extending according to at least two different directions and said profiles are in themselves neither tubular nor composed of a simple plan metal band. As developed further, said profiles can exhibit a U-shaped section or others.

To enable to link said profiles, said layout comprises fastening means composed of a weld seam 9 linking said profiles at their junction e1, e2., said weld seam 9 being situated in said interior volum 8 of the profiles 1, 2.

By providing “semi-open” profiles and by placing the weld seam 9 in the interior volume that they delineate, said weld seam 9 is thus masked and need not be eliminated partially for aesthetic reasons and/or operating reasons. The link between the profiles is thus made stronger and tighter. Similarly, no excessive thickness of material due to the weld seam being available at the external faces of the profiles, the finishing works of said excessive thickness are facilitated.

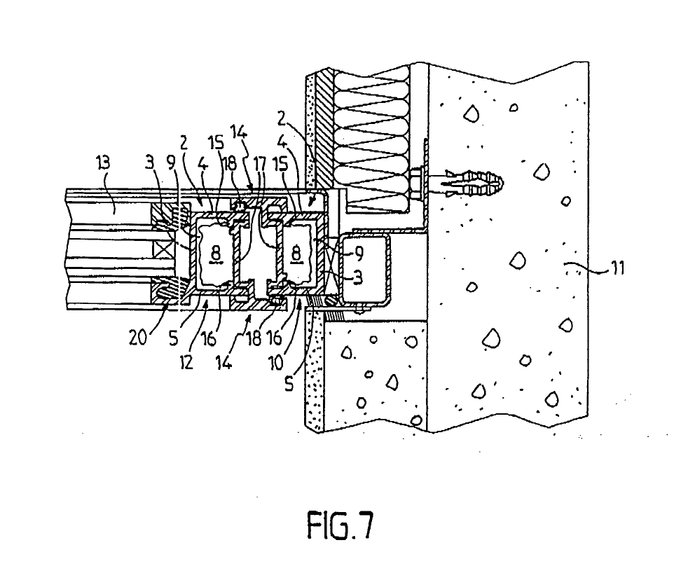

As FIGS. 2a to 2c, FIG. 7 illustrate a window, glazed door or similar according to the invention comprising a frame 10 and a chassis 12 forming respectively a first and a second layout according to the invention, i.e., delineated by “semi-open” profiles 2 assembled by an interior weld seam 9.

As illustrated by this particular example, all or part of the profiles 1, 2 layouts according to the invention can be fitted with closing means 14 of a portion at least of their interior volume 9. It will be thus possible to mask said weld seam 9 entirely.

The latter is more particularly intended, for example, along the portion of said web(s) 3 and of said wing(s) 4, 5 being in the portion of said interior volume 8 sealed said closing means 14. Said closing means 14 can besides extend from one end to the other of said profiles.

Said profiles exhibit, on each of the wings 4, 5, a stop 15, 16 against which the closing element 17 is stopped. Said closing means 17 can then be composed, notably, of rabbets 14 and/or leaves resting on said stops 15, 16. Said closing means can also be composed of another profile.

Said rabbets 14 may accommodate a gasket 18.

As illustrated on FIG. 7, the rabbets 17 closing each of the profiles 2 represented rest against one another by their gasket 18 when the window 13 is in closed position.

As regards the form of the profiles, as already mentioned, said form can bit quite varied. For exemplification purposes, as illustrated on Figures Be to 8g, said profiles comprise one said web 3 and at least two said wings 4, 5 extending opposite one another from ends of said web 3, perpendicularly to said ends.

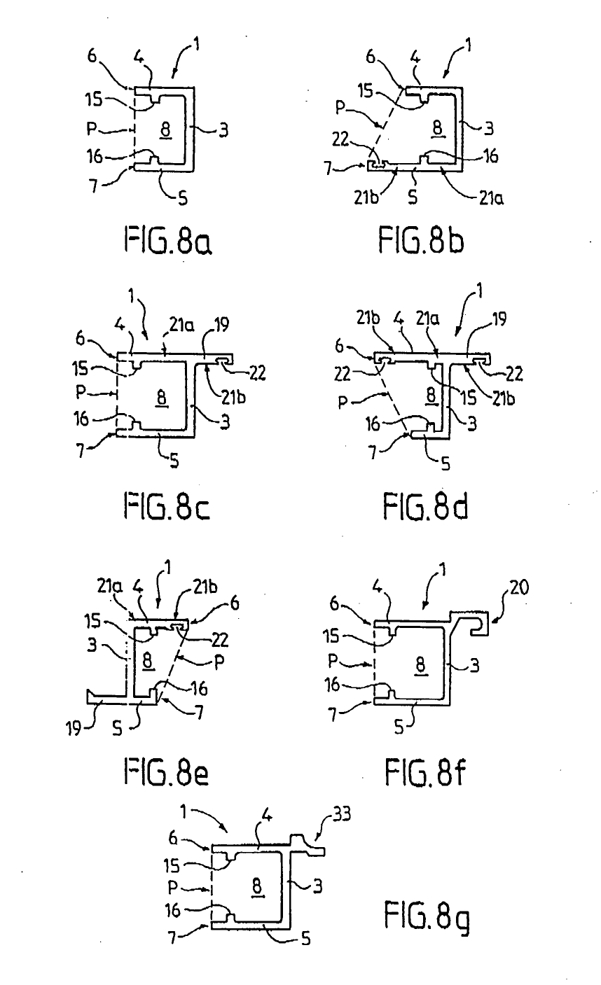

It can thus be defined a “base” section, such as illustrated on FIG. 8a, wherein both wings 4, 5 exhibit the some length. With reference again to FIG. 7, it can be noted that the stanchion 10 of the frame exhibits such a section.

One of the wings 4 can also be extended beyond the other 15, as illustrated on FIG. 8b. It can also be extended by a third wing 19 situated on the other side of the web 3, as illustrated on FIG. 8c. Said previous characteristics can still be combined, either at the same wing, as illustrated on FIG. 8d or at the other wing, as illustrated on FIG. 8e.

With reference again to FIG. 8f, it can be noted that the profiles according to the invention can also comprise a protuberance 20, notably intended to allow as well hooking a gasket as illustrated on FIG. 7 with the stanchion 12 of the chassis.

In order to machine the patterns, the web 3 and/or the wings 4, 5, 19 of said profiles can exhibit a relatively large thickness, as already mentioned. As illustrated on FIG. 8g, they can also exhibit one such material excrescency 33.

With reference again to FIGS. 8b, 8c, 8d or 8e, it can be noted that one 4 at least of said branches fitted with one of said stops 15, 16 exhibit, on the one hand, a first portion 21a delineating a portion of the contour of the interior volume 8 sealed by said closing means 14, and, on the other hand, a second so-called free portion 21b, exhibiting one said longitudinal specific groove 22, capable of accommodating a gasket. Said first and second portions 21a, 21b can be situated on either side of the stop 11 in question or on the same side, according to the profile used.

Profiles of a same layout according to the invention may exhibit the same section.

According to the invention, and as shown in FIG. 14, the assembly of the opening element 3, 4, 5 with the closing element 17 is done using clamping mechanisms 39 held inside the space 8, and on which the closing element 17, once supported on the stops 15, 16 comes to be affixed.

In particular, into the groove comprised of a web 3, the wings 4, 5 and the stops 15, 16, one or more clamps 39 are slid, then held pressed against the stops by means of a screw 40 that is supported on the web 3 and on the clamp 39.

The closing element 17 can thus be supported on the stops 15, 16 and affixed by means of the screw 41, the stops 15, 16 being fit tightly between the clamp 39 and the closing element 17, as shown in FIG. 14.

To assemble a layout according to the invention, one can proceed as follows. One positions against one another the ends of the profiles forming the layout. The junction can be welded at their interior volume which can be sealed using rabbets.

One can also realize finishing operations such as polishing or applying a patina on the external surfaces of said profiles.

According to the invention, and as shown in FIGS. 11 to 13, the profiled sections 1, 2 comprising, in addition, small pieces of wood 37, defining a bridge element between two adjoining parts of the opening structure, having in addition, locally or not, at least one excessive thickness 38 of material that makes possible the creation of personalizable moldings, working with the material, to produce the decoration of the profile.

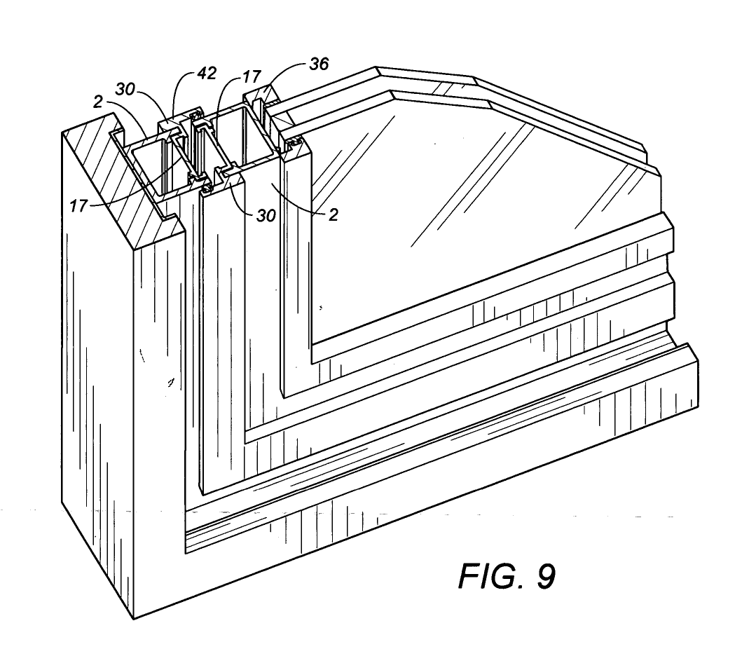

According to a particular embodiment mode of the invention, as shown in FIGS. 9 to 12, the opening element 1, 2 comprises, in addition, a supplemental wing 36 having, locally or not, at least one excessive thickness 43 of material that makes possible the realization of personalizable moldings 31 working with the material, to produce the decoration of the profile.

Here again, the fact of having provided excessive thicknesses that are not applicable for the strength calculation, makes it possible to create any type of decoration by moldings without increasing the stock inventory of parts to be managed or also the number of technical tests for each case.

The fixed or mobile closing devices for openings in buildings such as, notably, window, glazed door or similar, according to the invention may comprise a double glazing.

Naturally, other embodiments, available to the professional, could have been contemplated without departing from the framework of the invention.

1. A metal profile of shop window construction, comprising:
a fixed frame and an opening leaf, having a closed tubular cross section defining an interior space said fixed frame and/or opening leaf being present in the form of an arrangement of profiled sections defining said closed tubular cross section, each profiled section comprising at least one opening element, one closing element, and means for affixing the opening and closing elements to each other, each opening element comprising at least one web and two wings defining at least two longitudinal edges extending from one end of the profiled section to the other, and linked by all or part of the web and the wings, each closing element present at least in the form of a rabbet designed to connect the two wings of the corresponding opening element in order to form the closed tubular cross-section, the closing element having, in addition, locally or not, at least one excessive thickness of material that makes it possible to create personalizable moldings, working with the material, and to create decoration of the profile.

2. A profile, according to claim 1, wherein the rabbet is extended by a covering wing arranged longitudinally relative to the profiled sections, and on the outside relative to the profile, at the level of which moldings are provided.

3. A profile, according to claim 1, in which the closing element has an excess thickness greater than one millimeter.

4. A profile, according to claim 1, wherein all or part of said profiled sections is fitted with closing means of a portion at least of their interior volume.

5. A profile, according to claim 1, in which wherein the profiled sections have on each of the wings a stop opposite, on which the closing element is supported.

6. A profile, according to claim 5, wherein one or more of the wings equipped with one of the stops has a first portion defining a part of the contour of the interior spaced blocked by the closing elements and a second portion, considered free, having a longitudinal groove fitted to accommodate a watertight seal.

7. A profile, according to claim 1, wherein assembly of the opening element with the closing element is done using clamping mechanisms held inside the space, and on which the closing element, once supported on the stops comes to be affixed.

8. A profile, according to claim 1, wherein said web and at least two of the wings, extend opposite from the ends of the web, perpendicular to them.

9. A profile, according to claim 1, wherein the profiled sections further comprise pieces of wood, defining a bridge element between two adjoining parts of the opening structure, having in addition, locally or not, at least one excessive thickness of material that makes possible the creation of personalizable moldings, working with the material, to produce the decoration of the profile.

10. A profile, according to claim 1, wherein said opening element comprises a supplemental wing having, locally or not, at least one excessive thickness of material that makes possible the realization of personalizable moldings working with the material, to produce the decoration of the profile.

11. A profile, according to claim 1, wherein the profile is comprised of extruded bronze.

12. Window frame, window holder and/or similar device comprised of a profile according to claim 1.
